(19) United States
(12) Patent Application Publication
(10) Pub. No.: US 2024/0185483 A1
(43) Pub. Date: Jun. 6, 2024

(54) PROCESSING PROJECTION DOMAIN DATA PRODUCED BY A COMPUTED TOMOGRAPHY SCANNER

(71) Applicant: KONINKLIJKE PHILIPS N.V., EINDHOVEN (NL)

(72) Inventors: MIKHAIL BORTNIKOV, MOSKVA (RU); NIKOLAS DAVID SCHNELLBAECHER, LUBECK (DE); FRANK BERGNER, HAMBURG (DE); MICHAEL GRASS, BUCHHOLZ IN DER NORDHEIDE (DE)

(21) Appl. No.: 18/287,534

(22) PCT Filed: Apr. 22, 2022
(86) PCT No.: PCT/EP2022/060676

§ 371 Date: Oct. 19, 2023

(30) Foreign Application Priority Data
Apr. 23, 2021 (RU) 2021111695

(51) Int. Cl. G06T 11/00

(52) U.S. Cl. CPC G06T 11/006

(57) ABSTRACT

An output dataset is produced that comprises projection domain data for a desired/target imaging angle. Input datasets are processed that contain projection domain data captured/obtained at the desired/target imaging angle, as well as projection domain data captured/obtained at one or more further predetermined imaging angles. to produce the output dataset.

### FIELD OF THE INVENTION

The present invention relates to the field of computed tomography (CT) and, in particular, to processing projection domain data generated during a CT scanning procedure.

### BACKGROUND OF THE INVENTION

CT imaging is becoming a staple in medical imaging process in order to aid the assessment and diagnosis of a patient/subject.

A conventional CT scanner includes an x-ray generator mounted on a rotatable gantry opposite one or more integrating detectors. The x-ray generator rotates around an examination region located between the x-ray generator and the one or more detectors and emits (at least) x-ray radiation that traverses the examination region and a subject and/or object disposed in the examination region. The one or more detectors detect radiation that traverses the examination region and generate a signal, known as projection domain data or simply projection data, indicative of the examination region and the subject and/or object disposed therein. The projection domain data refers to the raw detector data and can be used to form a sinogram, the latter being a visual representation of the projection domain data captured by the detector(s).

A reconstructor is typically further used to process the projection domain data and reconstruct a volumetric image of the subject or object, i.e. generate image domain data. The volumetric image is composed of a plurality of cross-sectional image slices which are each generated from the projection domain data through a process of tomographic reconstruction, such as through application of a filtered back projection algorithm. The reconstructed image data is effectively an inverse Radon transform of the raw projection domain data.

There is an ongoing desire to improve the operation of CT scanners and, in particular, improve the quality of images produced by CT scanners.

### SUMMARY OF THE INVENTION

According to examples in accordance with one aspect of the invention, there is provided a computer-implemented method of processing projection domain data generated by a CT scanner.

The computer-implemented method comprises: obtaining a first input dataset comprising projection domain data generated by the CT scanner at a desired imaging angle, wherein the CT scanner is configured to generate projection domain data at different imaging angles with respect to an examination region in a scanning operation; obtaining at least one further input dataset, each comprising projection domain data generated by the CT scanner at a respective at least one further imaging angle, wherein a difference between the desired imaging angle and each respective further imaging angle is predetermined; inputting the first input dataset and the at least one further input dataset to a machine-learning algorithm, wherein the machine-learning algorithm is configured to process the first input dataset and the at least one further input dataset to generate an output dataset, wherein the output dataset is different to the first input dataset and comprises projection domain data at the desired imaging angle with respect to the examination region; and processing, using the machine-learning algorithm, the first input dataset and the at least one further input dataset to generate the output dataset.

The present invention therefore proposes to process projection domain data, i.e. raw detector data, before it is reconstructed into image data. In particular, input projection domain data obtained at a plurality of imaging angles with respect to an examination region is processed, using a machine-learning method, to provide output projection domain data at a single imaging angle, the desired imaging angle.

The input projection domain data includes a first input dataset, comprising projection domain data obtained at the desired imaging angle, and one or more (i.e. at least one) further input datasets, comprising projection domain data obtained at predetermined imaging angles with respect to the desired imaging angle. This facilitates a consistent input to the machine-learning method.

An underlying recognition of this inventive concept is that projection domain data obtained at different imaging angles can provide useful spatial information or additional information for processing, e.g. reducing noise, in projection domain data obtained at a specific, desired angle. For instance, different imaging angles may still image a same area/volume of the subject or examination region, meaning that there is more available information for a particular viewpoint. This allows for naturally existing information to be used to increase the amount of data for machine-learning algorithms without additional cost, i.e. additional image acquisition.

Thus, there is a proposed a concept of a multi-channel input for a machine-learning method, where each channel provides projection domain data obtained at a different imaging angle.

An imaging angle may be defined as an angle that a radiation source of the CT scanner emits radiation within an examination region, e.g. with respect to a center of the examination region. In particular, for conventional CT scanners in which the radiation source is mounted on a rotating gantry, the imaging angle may be defined as the angle that the radiation source makes with a horizontal plane passing through the center of rotation of the rotating gantry.

In particular examples, each dataset may comprise projection domain data for a particular part of a projection volume, being a volume of an examination region irradiated by the CT scanner during a particular instance of the scanning operation. The part of the projection volumes of the at least one, i.e. one or more, further input dataset(s) may at least partially overlap the part of the projection volume of the first input dataset.

The steps of the computer-implemented method may be performed by a processing arrangement or processing circuitry. The machine-learning algorithm may be hosted by the processing arrangement or processing circuitry. The at least one further input dataset may comprise a single further input dataset or a plurality of further input datasets, e.g. two or more further input datasets. If the further input datasets comprise a plurality of further input datasets, the predetermined angle between the desired imaging angle and each respective further imaging angle may be different for each further input dataset.

It should be apparent that the difference between the desired imaging angle and each respective further imaging angle is non-zero.

In some embodiments, the method further comprises using the machine-learning algorithm to reduce, based on the first input dataset and the at least one further input dataset, at least one of noise and artefacts in the projection domain data of the first input dataset to thereby generate the output dataset. Thus, the machine-learning method may be configured to reduce noise and/or artefacts in the projection domain data of the first input dataset, using the first input dataset and the one or more further input datasets, to thereby generate the output dataset. The proposed concept is advantageous when used to reduce noise/artefacts in the projection domain data. This is because missing or erroneous data in the first input dataset can be supplemented or corrected using data found in the one or more further input datasets, which may provide, for example, information on a same volume of the subject.

In some examples, the method further comprises using the machine-learning algorithm to perform, based on the first input dataset and the at least one further input dataset, spectral filtering of the projection domain data of the first input dataset. Thus, the machine-learning method may be configured to perform spectral filtering of the projection domain data at the desired imaging angle, using the first input dataset and the one or more further input datasets, to thereby generate the output dataset.

In some examples, the at least one further input dataset comprises at least a first further input dataset comprising projection domain data generated by the CT scanner at a first imaging angle, the difference between the desired imaging angle and the first imaging angle being equal to π.

In at least one example, for each further input dataset, the difference between the desired imaging angle and the respective further imaging angle is a multiple of a first predetermined angle. The first predetermined angle may be equal to the smallest change in imaging angle carried out by the CT scanner during a scanning operation. This embodiment makes use of the natural correlations in the projection domain data captured in close proximity, i.e. at the nearest available imaging angles, to one another, e.g. that are captured in sequence.

However, the skilled person will appreciate that any predetermined angle may be suitable for the present invention, e.g. any angle less than 0.5π or, more preferably, less than 0.1π.

The at least one further input dataset may comprise a second further input dataset comprising projection domain data generated by the CT scanner at a second imaging angle, wherein the difference between the desired imaging angle and the second imaging angle being the first predetermined angle; and a third further input dataset comprising projection domain data generated by the CT scanner at a third imaging angle, wherein the difference between the third imaging angle and the desired imaging angle is the first predetermined angle. The third imaging angle is different to the second imaging angle. For instance, if the desired imaging angle is 0, then the second imaging angle may be θ+Δθ (or θ+π+Δθ) and the second imaging angle may be θ−Δθ (or θ+π−Δθ). In both cases, the difference between the second/third imaging angle and the desired angle is the same, but the imaging angles differ.

The at least one further input dataset may comprise a fourth further input dataset comprising projection domain data generated by the CT scanner at a fourth imaging angle, wherein the difference between the desired imaging angle and the second fourth imaging angle being a second predetermined angle, wherein the second predetermined angle is greater than the first predetermined angle; and a fifth further input dataset comprising projection domain data generated by the CT scanner at a fifth imaging angle, wherein the difference between the fifth imaging angle and the desired imaging angle is the second predetermined angle.

Preferably, the magnitude of the second predetermined angle is twice the magnitude of the first predetermined angle.

In some examples, the at least one further input dataset comprises no more than ten further input datasets. To help keep correlations in the projection domain data, from the first input dataset and the one or more further input datasets, sufficiently large, e.g. for ensuring accurate processing by the machine-learning algorithm, it is useful to limit the maximum number of inputs to a restricted amount.

Optionally, the CT scanner is configured to generate projection domain data for each of a plurality of different parts of a projection volume with respect to the subject, wherein the projection volume is a volume of the examination region, and each of the at least one further input dataset is configured to comprise projection domain data having a part of the projection volume that at least partly overlaps the part of the projection volume of the projection domain data of the first input dataset.

This approach is of particular use for helical scan trajectories, where the correlation of projection domain data obtained at different angles will decrease with increasing acquisition trajectory pitch. By taking account of the part of the projection volumes associated with each instance of projection domain data, this change can be taken into account. In particular examples, this change can be taken into account by using the geometrical knowledge about the helical scan trajectory, including knowledge about the movement of the patient, e.g. upon a support, and trajectory pitch.

The method may further comprises, for each of at least one further input dataset, prior to inputting the first input dataset and the at least one further input dataset into the machine-learning algorithm: processing the further input dataset to remove any portions of the projection domain data of the further input dataset that correspond to parts of the projection volume of the projection domain data of the further input dataset that do not overlap the projection volume of the first input dataset.

In other words, a zero padding approach could be used to remove projection domain data from the one or more further input datasets that does not correlate to any projection domain data found in the first input dataset, i.e. projection domain data of the further input dataset(s) that corresponds to a volume of the examination region or subject that is not irradiated during acquisition of the projection domain data of the first input dataset.

Optionally, the CT scanner comprises a rotating gantry that rotates about a center of rotation, a radiation source rotatably supported on the rotating gantry and configured to rotate with the rotating gantry and emit radiation that traverses the examination region, and a detector array rotatably supported on the rotating gantry and configured to rotate with the rotating gantry and to generate projection domain data responsive to radiation emitted by the radiation source through the examination region, wherein the imaging angle is an angle that the radiation source makes with respect to a horizontal plane.

The horizontal plane may pass through a center of rotation of the rotating gantry, e.g. a center of the examination region.

There is also proposed a computer program product comprising computer program code means which, when executed on a computing device having a processing system, cause the processing system to perform all of the steps of any herein described method. A computer readable medium may contain computer program or executable instructions imbedded therein.

There is also proposed a device configured to process projection domain data generated by a CT scanner.

The device comprises processing circuitry or a processing arrangement and a memory containing instructions that, when executed by the processing circuitry or the processing arrangement, configure the processing circuitry or the processing arrangement to obtain a first input dataset comprising projection domain data generated by the CT scanner at a desired imaging angle, wherein the CT scanner is configured to generate projection domain data at different imaging angles with respect to an examination region in a scanning operation; obtain at least one further input dataset, each further input dataset comprising projection domain data generated by the CT scanner at a respective at least one further imaging angle, wherein the difference between the desired imaging angle and each respective further imaging angle is predetermined; input the first input dataset and the at least one further input dataset to a machine-learning algorithm, wherein the machine-learning algorithm is configured to process the first input dataset and the at least one further input dataset to generate an output dataset, wherein the output dataset is different to the first input dataset and comprises projection domain data at the desired imaging angle with respect to the examination region; and process, using the machine-learning algorithm, the first input dataset and the at least one further input dataset to generate the output dataset.

There is also proposed a CT system comprising the device and the CT scanner. The CT scanner may comprise a rotating gantry that rotates about a center of rotation, a radiation source rotatably supported on the rotating gantry and configured to rotate with the rotating gantry and emit radiation that traverses the examination region, and a detector array rotatably supported on the rotating gantry and configured to rotate with the rotating gantry and to generate projection domain data responsive to radiation emitted by the radiation source through the examination region, wherein the imaging angle is an angle that the radiation source makes with respect to a horizontal plane.

The device may be configured to perform any herein described method and vice versa. Similarly, the computer program product may be configured to, when executed, carry out any herein described method and vice versa. The skilled person would be able to appropriately modify the device, method and/or computer program product accordingly.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates an imaging system including a CT scanner;

FIG. 2 conceptually illustrating different imaging angles for a CT scanner of an imaging system;

FIGS. 3 and 4 illustrate conceptual overviews of the present disclosure;

FIG. 5 illustrates exemplary images produced using projection domain data;

FIG. 6 is a flowchart illustrating a method; and

FIG. 7 illustrates a processing arrangement.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides an approach for producing an output dataset comprising projection domain data for a desired/target imaging angle. A machine-learning algorithm processes input datasets containing projection domain data captured/obtained at the desired/target imaging angle as well as projection domain data captured/obtained at one or more further predetermined imaging angles to produce the output dataset.

Embodiments can be employed to perform noise/artefact reduction in the projection domain space of CT projection domain data.

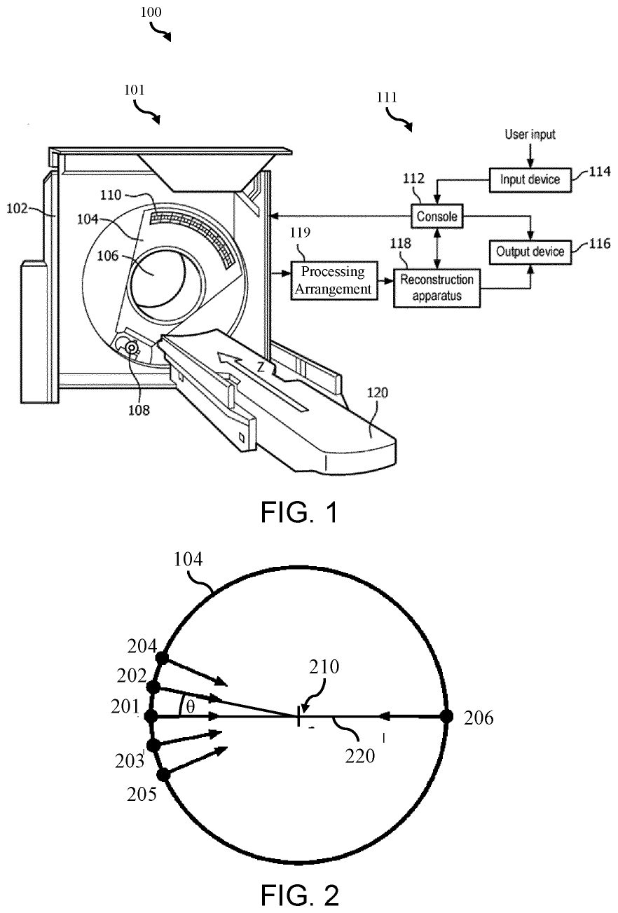

FIG. 1 illustrates an imaging system and, in particular, a CT imaging system 100, in which embodiments of the present invention can be employed.

The CT imaging system 100 comprises a CT scanner 101 and processing interface 111, which processes and performs actions using data generated by the CT scanner 101.

The CT scanner 101 includes a generally stationary gantry 102 and a rotating gantry 104. The rotating gantry 104 is rotatably supported by the stationary gantry 102 and rotates around an examination region about a longitudinal or z-axis.

A patient support 120, such as a couch, supports an object or subject such as a human patient in the examination region. The support 120 is configured to move the object or subject for loading, scanning, and/or unloading the object or subject.

A radiation source 108, such as an x-ray tube, is rotatably supported by the rotating gantry 104. The radiation source 108 rotates with the rotating gantry 104 and emits radiation that traverses the examination region 106.

A radiation sensitive detector array 110 subtends an angular arc opposite the radiation source 108 across the examination region 106. The detector array 110 includes one or more rows of detectors that extend along the z-axis direction, detects radiation traversing the examination region 106, and generates projection domain data indicative thereof. The projection domain data may, for instance, be cone-beam projection data.

Thus, the CT scanner 101 is able to generate/capture projection domain data. As the rotating gantry 104 rotates about the examination region 106, an imaging angle of the CT scanner 101, with respect to the examination region, changes. Conceptually, this can be understood as the direction in which radiation is emitted by the radiation source 108 changing as the rotating gantry 104 rotates. Projection domain data is generated by the CT scanner 101 as each of a plurality of imaging angles of the CT scanner 101 during a CT scanning procedure. Thus, a plurality of datasets are generated, each dataset containing projection domain data obtained at a different point in time, with temporally adjacent datasets being generated at different imaging angles.

The patient support 120 may move along the longitudinal axis z during the CT scanning procedure. This may be done in steps stages. The rotating gantry 104 may make a complete 2π rotation between each movement of the patient support 120, a process known as a “circular scan trajectory” approach or “stop and shoot” method.

Another imaging approach is the “helical scan trajectory” approach or helical CT scanning. In this approach, projection domain data is obtained during continuous rotation of the gantry and simultaneous translation of the patient support.

A “projection volume” refers to the total volume of the examination region that is imaged during a CT scanning procedure. Each dataset generated by the CT scanner comprises projection domain data taken at a particular imaging angle and representing a particular part of the projection volume (e.g. representing the irradiated part of the projection volume). Typically, the part of the projection volume captured at a particular imaging angle is conical or cone-shaped.

A general-purpose computing system or computer serves as an operator console 112 and includes an input device(s) 114 such as a mouse, a keyboard, and/or the like and an output device(s) 116 such as a display monitor or the like. The console 112 allows an operator to control operation of the system 100.

A reconstruction apparatus 118 processes the projection domain data and reconstructs volumetric image data. The data can be displayed through one or more display monitors of the output device(s) 116.

The reconstruction apparatus 118 may employ a filtered-backprojection (FBP) reconstruction, an image domain and/or projection domain reduced noise reconstruction algorithm, e.g., an iterative reconstruction and/or other algorithm. It is to be appreciated that the reconstruction apparatus 118 can be implemented through at least one processor, which executes a computer readable instruction(s) encoded or embedded on a computer readable storage medium, such as physical memory and other non-transitory medium. Additionally or alternatively, the one or more processors can execute a computer readable instruction(s) carried by a carrier wave, a signal and other transitory or non-transitory medium.

The present invention relates to the processing of projection domain data generated by the CT scanner 101, e.g. by a device such as the processing arrangement 119. The skilled person will appreciate that this projection domain data may be obtained directly from the CT scanner or via one or more other circuit element, such as a memory or buffer (not shown) that temporarily, semi-permanently and/or permanently stores the projection domain data.

FIG. 2 conceptually illustrates a cross-section of the rotating gantry 104 to demonstrate different imaging angles for the CT scanner 101, as shown on a horizontal plane through the rotation iso-center.

In particular, FIG. 2 illustrates how a CT scanner is able to obtain projection domain data at a plurality of different imaging angles with respect to an examination region. FIG. 2 demonstrates example positions 201, 202, 203, 204, 205, 206 for the radiation source as the rotating gantry rotates. The skilled person will appreciate that these positions are merely exemplary, and that the radiation source may be positioned at other angles, e.g. depending upon the capability of the CT scanner and the CT scanning procedure. Projection domain data generated at a respective position means that respective projection domain data at different imaging angles is generated.

FIG. 2 also illustrates how, for each position of the radiation source, an imaging angle, indicated using arrows, changes. In the illustrated example, the CT scanner 101 rotates about a center of rotation 210, e.g. an axis passing through the center of the CT scanner-into/out of the page. Thus, the imaging angle, in the illustrated example, is an angle about the center of rotation of the CT scanner 101. Put another way, the imaging angle represents a position of the radiation source about the cross-section of the rotating gantry.

In particular, the imaging angle may be an angle between the central direction of radiation emission provided by the radiation source and a horizontal plane 220 that passes through the center of rotation 210 in this cross-section view. Typically, the imaging angle is the angle between a hypothetical line passing through the radiation source, the center of rotation 210 and the horizontal plane 220.

Typically, when the radiation source is at a particular position, e.g. position 201, then the radiation sensitive detector array 110 is positioned at an opposite position, e.g. position 206, of the cross-sectional view. As previously explained, it may subtend an angular arc opposite the radiation source 108.

The present invention proposes to generate enhanced, improved, or modified projection domain data for a desired imaging angle, e.g. an angle θ, using projection domain data from the desired imaging angle and one or more further imaging angles. The difference between the desired imaging angle and each further imaging angle is predetermined.

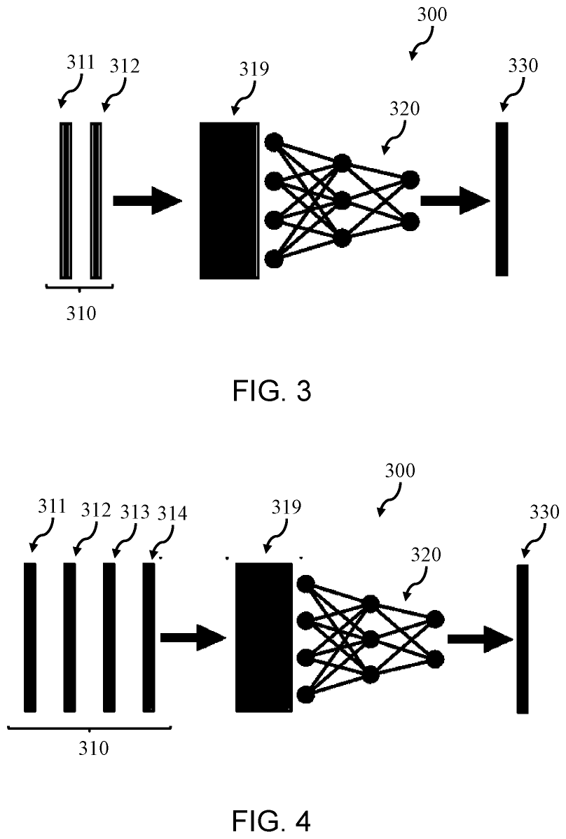

FIGS. 3 and 4 conceptually illustrate an overview 300 adopted by various embodiments. One approach comprises using a machine-learning algorithm 320 to process some input datasets 310, comprising projection domain data, to produce an output dataset 330. The machine-learning algorithm thereby operates in the projection domain.

The output dataset 330 comprises processed and/or modified projection domain data at a desired imaging angle. The input datasets 310 comprise a first input dataset 311, comprising projection domain data at the desired imaging angle, and one or more further input datasets 312, 313, 314, e.g. a single further input dataset 312 as illustrated in FIG. 3 or more than one further input datasets 312, 313, 314 as illustrated in FIG. 4. Each further input dataset comprises projection domain data at a further imaging angle, wherein an angle between the desired imaging angle and the further imaging angle is predetermined.

Each input dataset contains projection domain data captured by the CT scanner, which may have been pre-processed, e.g. to filter out certain predetermined frequencies or the like. The output dataset contains projection domain data that has undergone processing by the machine-learning algorithm.

Thus, rather than simply processing projection domain data at only the desired imaging angle to produce the output dataset, the input to the machine-learning algorithm is augmented/supplemented by using projection domain data obtained at one or more different angles. In other words, the machine-learning algorithm receives, as input, “original” projection domain data at a desired imaging angle, and one or more other imaging angles, and produces, as output, processed and/or modified projection domain data at the desired imaging angle.

As described in more detail below, the machine-learning algorithm 320 may be configured to improve image characteristics of any images that are subsequently produced using the projection domain data at the desired imaging angle by using the projection domain data obtained at the other imaging angle when modifying the projection domain data at the desired imaging angle. The imaging characteristics may include, for instance, an amount of noise, a number of artefacts, a resolution, a homogeneity, signal-to-noise ratio, and/or a level of contrast.

In particular, the machine-learning algorithm may be configured to perform noise reduction and/or artefact reduction on the projection domain data.

In some examples, the machine-learning algorithm may be configured to perform spectral filtering of the projection domain data at the desired imaging angle. This process can be improved, e.g. to preserve elements, by using projection domain data at the further imaging angle(s).

As one example, the machine-learning algorithm may be configured to receive low-dose projection domain data and output simulated high-dose projection domain data—i.e. low-noise projection domain data with noise levels equal to high-dose projection domain data.

In particularly advantageous embodiments, for at least one of the one or more further input datasets, the difference between the further imaging angle and the desired imaging angle is π, i.e. 180°. This embodiment recognizes that at least some parts of the radiation, i.e. rays, emitted by the radiation source at either of these two imaging angles will be subject to the same attenuation from the elements positioned in the examination region, provided that the parts of the volume irradiated at both imaging angles at least partly overlap. Hence, projection domain data generated at both of these angles will contain similar information that can be used to augment the projection domain data obtained at one of these angles.

By way of illustrative example, further referring back to FIG. 2, the first input dataset 311 may comprise projection domain data obtained when the radiation source is at the position 201 and a first further input dataset 312 may comprise projection domain data obtained when the radiation source is at the position 206.

As a specific working example, the one or more further input datasets may comprise only a single further input dataset 312, e.g. as illustrated in FIG. 3, having projection domain data obtained at a further imaging angle, wherein a difference between the further imaging angle and the desired imaging angle is π. In other examples, the one or more further input datasets may include more than one further input dataset, e.g. as illustrated in FIG. 4, or at least one which is similar to the single further input dataset previously described.

In some examples, for at least one of the one or more further input datasets 312, 313, 314, the difference between the further imaging angle and the desired imaging angle is a multiple of a predetermined angle Δθ, i.e. is equal to k·Δθ. Thus, the projection image data of the one or more further input datasets may be obtained at an imaging angle θ±Δθ, θ±2Δθ, . . . , θ±k·Δθ.

In some examples, it is preferred that the one or more further input datasets comprises no more than 20 further input datasets, e.g. so that k is no greater than 20, or more preferably, no more than 10 further input datasets, e.g. so that k is no greater than 10, or even more preferably, no more than 5 further input datasets, e.g. so that k is no greater than 5. This helps keep correlations in the corresponding projection domain data sufficiently large, thereby improving the performance of the machine-learning algorithm.

In some examples, the one or more further input datasets may comprise at least four datasets: a first input dataset, a second input dataset, a third input dataset, and a fourth input dataset. The first and second input datasets may comprise projection domain data obtained at an imaging angle of θ+Δθ and θ−Δθ respectively, where θ is the desired imaging angle and Δθ is the predetermined angle. The third and fourth input datasets may comprise projection domain data obtained at an imaging angle of θ+2·Δθ and θ−2·Δθ, respectively.

The predetermined angle Δθ may, for instance, be equal to the smallest change in imaging angle carried out by the CT scanner during a scanning operation. This smallest change may, for example, be defined by the CT scanner itself, i.e. according to some prescheduled and/or predetermined scanning operation. Thus, the predetermined angle Δθ may be equal to the fixed or predetermined angular increment of the rotation of the CT scanner during the scanning operation.

By way of illustrative example, further referring back to FIG. 2, the first input dataset 311 may comprise projection domain data obtained when the radiation source 108 is at the position 201, a first further input dataset 312 may comprise projection domain data obtained when the radiation source is at the position 202 and a second further input dataset 313 may comprise projection domain data obtained when the radiation source is at the position 203.

In some examples, the value of Δθ is equal to π. This may occur if, during a CT scanning procedure, multiple measurements are taken at the desired imaging angle and/or at an imaging angle opposite, i.e. with a difference of π, to the desired imaging angle, e.g. during perfusion measurements or the like.

In preferred examples, at least one of the further input datasets comprises projection imaging data obtained at a different imaging angle to the projection imaging data of the first input dataset.

In some examples, for at least one of the one or more further input datasets, the difference between the further imaging angle and the desired imaging angle is equal to a sum of π and a multiple of the predetermined angle Δθ. Thus, the difference between an imaging angle of the projection domain data of a further input dataset and the desired imaging angle of the projection domain data of the first input dataset may be π±k·Δθ.

Of course, any other form of predetermined angles can be used. For instance, there may be more than one predetermined angle, e.g. Δθ₁, Δθ₂ . . . Δθₖ, of which at least one is preferably, but not essentially, equal to π and/or a multiple of π.

Any combination of the previously identified predetermined angles may be used. As previously explained, it is particularly advantageous if the one or more further input datasets includes at least one further input dataset for which the projection domain data is obtained/captured at an imaging angle that is π offset from the imaging angle of the projection domain data of the first input dataset.

As illustrated in FIGS. 3 and 4, the input datasets may be concatenated or otherwise grouped together to form a single dataset 319 that can act as the input for the machine-learning method.

The total number of input datasets for the machine-learning algorithm illustrated in FIGS. 3 and 4 is merely exemplary, and any number of suitable input datasets may be used.

The machine-learning algorithm is configured to process the input datasets 310 to provide, as output, an output dataset that includes processed projection domain data at the desired imaging angle. The processed projection domain data may have improved imaging characteristics, such as those previously described, compared to the imaging data contained in the first input dataset and/or be registered, transformed and/or converted to some predetermined coordinate system

The process f(.) performed by the machine-learning algorithm can be modelled as follows:

f(p(θ),p(θ+Δθ₁) . . . ,p(θ+Δθₖ)=\acute{p}(θ) (1)

where p(.) represents projection domain data of an input dataset at a particular angle, θ represents the desired imaging angle, Δθ₁, . . . , Δθₖ represent different differences in imaging angle, \acute{p}(θ) represents the processed projection domain data of the output dataset at the desired imaging angle,

The machine-learning algorithm is hosted by a processing arrangement.

Various embodiments of the present invention thereby make use of a machine-learning algorithm to process input datasets to produce an output dataset. A machine-learning method is capable of performing the feature registration tasks required, e.g. to map features of different input datasets to one another, in order to generate the output dataset.

A machine-learning algorithm is any self-training algorithm that processes input data in order to produce or predict output data. According to the embodiments of the present invention, the input data comprises input datasets, including the first input dataset and the one or more further input datasets, and the output data comprises the output dataset previously described.

Suitable machine-learning algorithms for being employed in the present invention will be apparent to the skilled person. Examples of suitable machine-learning algorithms include decision tree algorithms and artificial neural networks. Other machine-learning algorithms such as logistic regression, support vector machines or Naïve Bayesian models are suitable alternatives.

The structure of an artificial neural network, or, simply, neural network, is inspired by the human brain. Neural networks are comprised of layers, each layer comprising a plurality of neurons. Each neuron comprises a mathematical operation. In particular, each neuron may comprise a different weighted combination of a single type of transformation, e.g. the same type of transformation, sigmoid etc. but with different weightings. In the process of processing input data, the mathematical operation of each neuron is performed on the input data to produce a numerical output, and the outputs of each layer in the neural network are fed into the next layer sequentially. The final layer provides the output.

Methods of training a machine-learning algorithm are well known. Typically, such methods comprise obtaining a training dataset, comprising training input data entries and corresponding training output data entries. An initialized machine-learning algorithm is applied to each input data entry to generate predicted output data entries. An error between the predicted output data entries and corresponding training output data entries is used to modify the machine-learning algorithm. This process can be repeated until the error converges, and the predicted output data entries are sufficiently similar (e.g. +1%) to the training output data entries. This is commonly known as a supervised learning technique.

For example, where the machine-learning algorithm is formed from a neural network, weightings of the mathematical operation of each neuron may be modified until the error converges. Known methods of modifying a neural network include gradient descent, backpropagation algorithms and so on.

The training input data entries correspond to example input datasets. The training output data entries correspond to example output datasets.

As a working example, consider a scenario in which the machine-learning algorithm is to be trained to denoise some projection domain data, e.g. to produce denoised projection domain data. For this scenario, the output dataset would be denoised projection domain data, and the input datasets comprise projection domain data at a desired imaging angle and at least one other imaging angle.

In this scenario, a training input data entry and a training output data entry of the training dataset may be generated by first acquiring projection domain data known to produce one or more high quality images when processed, e.g. through manual intervention/selection and/or automated quality processing methods. The projection domain data should include projection domain data at the desired imaging angle and each further imaging angle. Noise, e.g. white or pink noise, may then be added to the projection domain data, to produce simulated low-quality projection domain data. The training input data entry is generated by selecting the simulated low-quality projection domain data at the desired/target imaging angle and one or more other projection domain data at the further imaging angle(s).

The “further imaging angles” used to train the machine-learning network do not need to be the exact same further imaging angles used during later inference, e.g. when executing a method according to an embodiment. However, for improved performance, it is preferred that the further imaging angles used during training and the further imaging angles used during inference are the same.

The machine-learning network may, for example, be a convolutional neural network (CNN), using a U-Net, ResNet or deep feed-forward neural network architecture. Thus, the machine-learning network may be a CNN-based machine learning framework, including popular feed-forward, encoder-decoder (U-Nets), or other popular CNN architectures consisting of various combinations of dense- or res-net building blocks.

From the foregoing, it will be understood that the proposed approach comprises inputting projection domain data obtained at different imaging angles and outputting projection domain data at a target/desired imaging angle having improved characteristics. The input datasets include projection domain data at the target/desired imaging angle, so that the proposed approach effectively improves the characteristics of this domain projection data.

The number of input datasets, i.e. input channels, may affect the number of feature maps in the first convolutional layer. In particular, the greater the number of input datasets, the greater the number of feature maps. A greater number of feature maps provide greater network capacity and, in principle, faciltiate the learning of more complicated representations from the training data distribution.

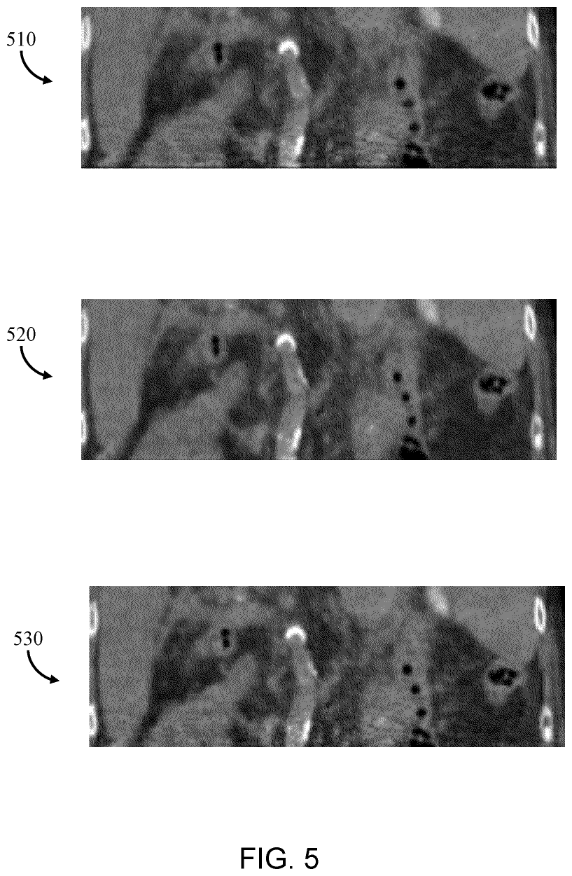

FIG. 5 illustrates the effect/impact of the various embodiments of the present invention. FIG. 5 provides three images depicting a same portion of a patient: a lower part of a coronal section. Each image is generated by processing a plurality of sets of projection domain data, each set of projection domain data being at a particular imaging angle. Each set of projection domain data has undergone a denoising process using a machine-learning method that denoise the set of projection domain data.

For the first image 510, each set of projection domain data is processed by a machine-learning method that receives, as input, projection domain data obtained only at the imaging angle of the set of the projection domain data.

For the second image 520, each set of projection domain data is processed according to the various embodiments of the present invention. In particular, each set of projection domain data is processed by a machine-learning method that receives, as input, a first input dataset comprising projection domain data obtained at the imaging angle, i.e. θ, of the set of the projection domain data and a further input dataset comprising projection domain data obtained at the opposite imaging angle, i.e. at θ+π, that has a predetermined relationship with the imaging angle of the set of the projection domain data.

For the third image 530, each set of projection domain data is processed using another embodiment of the present invention. In particular, each set of projection domain data is processed by a machine-learning method that receives, as input, a first input dataset comprising projection domain data obtained at the imaging angle, i.e. θ, of the set of the projection domain data, and two input dataset that comprises projection domain data at two respective further imaging angles that are equally spaced from the angle θ, i.e. at angles θ+Δθ. The value of Δθ may be equal to the smallest change in angle that is performed by the CT scanner during a CT scanning procedure.

As illustrated in FIG. 5, the use of projection domain data obtained at more than one imaging angle to process some specific projection domain data in the projection domain facilitates improved denoising, compared to using only projection domain data obtained at the desired imaging angle. The effect is most pronounced in the second image 520, produced using projection domain data obtained at the desired angle and an opposite angle. However, an improvement to the first image 510 is also seen in the third image 530.

It has previously been explained how each dataset generated by the CT scanner may contain projection domain data at a particular part of the projection volume. It has been recognized by this disclosure that the part of the projection volume of one dataset may at least partly overlap the part of the projection volume of another dataset.

To improve the performance of the machine-learning algorithm, in preferable examples, the part of the projection volume of each of the one or more further input datasets at least partly overlaps the projection volume of the first input dataset. In other words, the projection domain data of each of the further input datasets may represent at least a part of the projection volume part represented by, i.e. for which information is contained by, the projection domain data of the first input dataset.

The part of the projection volume represented by a particular dataset of projection domain data can be readily ascertained based on, for instance, a translation of the patient support and a rotation of the rotating gantry.

In some examples, prior to inputting the first and one or more further input datasets into the machine-learning algorithm each further input dataset may be processed to remove any portions of the projection domain data of the further input dataset that correspond to parts of the projection volume of the projection domain data of the further input dataset that do not overlap the projection volume of the first input dataset.

As one example, the parts of the projection domain data that do not correspond to parts of the projection volume that overlap the projection volume of the first input dataset may be “zeroed”, i.e. be subject to zero-padding. Other approaches would be apparent to the skilled person, e.g. replacing values with 1 rather than 0.

For each further input dataset, the parts of the projection domain data of that further dataset that represent the part of the projection volume that overlaps the part of the projection volume of the first input dataset may be identified based on metadata of the projection domain dataset, e.g. data that identifies a difference in imaging angle and/or change in position of the patient support along the z-axis, i.e. a translation of the patient support.

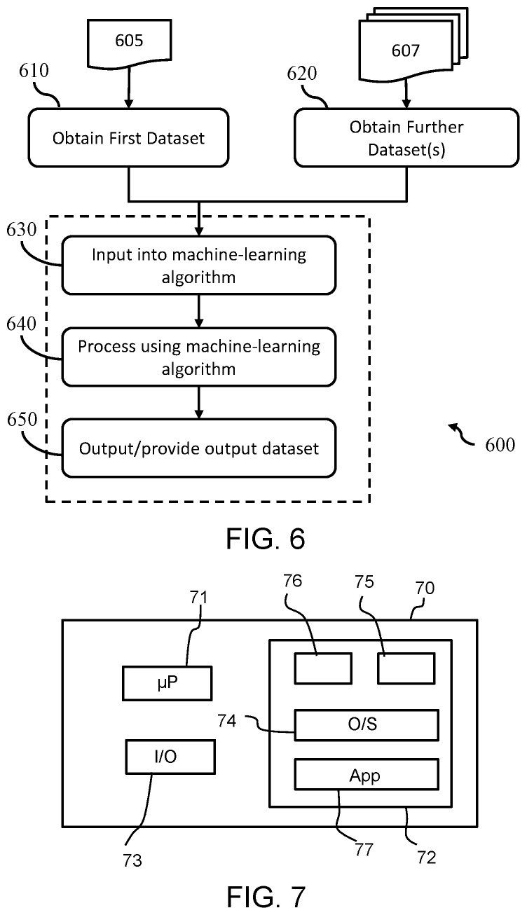

FIG. 6 illustrates a computer-implemented method 600 of processing projection domain data generated by a CT scanner. The method 600 may be performed by a device, such as the processing arrangement 119 of FIG. 1.

The method comprises a step 610 of obtaining a first input dataset 605 comprising projection domain data generated by the CT scanner at a desired imaging angle. The CT scanner is configured to, during a scanning operation, generate projection domain data at different imaging angles with respect to an examination region. An example of a suitable CT scanner has been previously described with reference to FIG. 1, although other examples will be readily apparent to the skilled person.

The method 600 also comprises a step 620 of obtaining one or more further input datasets 607, each comprising projection domain data generated by the CT scanner at a respective one or more further imaging angles, wherein the difference between the desired imaging angle and each respective further imaging angle is predetermined.

Examples for the further input datasets have been previously described and may be employed in the method 600.

The method 600 also comprises a step 630 of inputting the first input dataset and one or more further input datasets to a machine-learning algorithm. The machine-learning algorithm is configured to process the first input dataset and the one or more further input datasets to generate an output dataset, different to the first input dataset, comprising projection domain data at the desired imaging angle with respect to the examination region.

The method 600 also comprises a step 640 of processing the first and further input datasets to generate the output dataset.

In some embodiments of the present invention, the method 600 further comprises a step 650 of outputting the output dataset, i.e. from the processing arrangement. The output dataset may be provided, for example, to a reconstruction apparatus, e.g. for reconstructing one or more images from the projection domain data of the output dataset and/or to a memory, e.g. to store the projection domain data for later processing. Other approaches and purposes for the projection domain data will be apparent to the skilled person.

Step 630, 640 and 650 form an overall process of generating and outputting the projection domain data.

By way of further example, FIG. 7 illustrates an example of a device 70 or processing arrangement within which one or more parts of an embodiment may be employed. Various operations discussed above may utilize the capabilities of the device 70. For example, one or more parts of a system for processing an image with a CNN may be incorporated in any element, module, application, and/or component discussed herein. In this regard, it is to be understood that system functional blocks can run on a single computer or may be distributed over several computers and locations, e.g. connected via Internet.

The device 70 includes, but is not limited to, at least one of: a processor, a PC, a workstation, a laptop, a PDA, a palm device, a server, a storage, a cloud computing device, and a distributed processing system. Generally, in terms of hardware architecture, the device 70 may include one or more processing circuitries 71, memory 72, and one or more I/O devices 73 that are communicatively coupled via a local interface. The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processing circuitry 71 is a hardware device for executing software that can be stored in the memory 72. The processing circuitry 71 can be virtually any custom made or commercially available processing circuitry, a central processing unit (CPU), a digital signal processing circuitry (DSP), or an auxiliary processing circuitry among several processing arrangements associated with the device 70, and the processing circuitry 71 may be a semiconductor based microprocessing circuitry in the form of a microchip.

The memory 72 can include any one or combination of volatile memory elements, e.g., random access memory (RAM), such as dynamic random access memory (DRAM), static random access memory (SRAM), etc.) and non-volatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.. Moreover, the memory 72 may incorporate electronic, magnetic, optical, and/or other types of storage media. The memory 72 can have a distributed architecture, where various components are situated remote from one another, but can be accessed by the processing circuitry 71.

The software in the memory 72 may include one or more separate programs, each of which comprises an ordered listing of executable instructions for implementing logical functions. The software in the memory 72 includes a suitable operating system (O/S) 75, compiler 74, source code 73, and one or more applications 76 in accordance with exemplary embodiments. As illustrated, the application 76 comprises numerous functional components for implementing the features and operations of the exemplary embodiments. The application 76 of the device 70 may represent various applications, computational units, logic, functional units, processes, operations, virtual entities, and/or modules in accordance with exemplary embodiments, but the application 76 is not meant to be a limitation.

The O/S 75 controls the execution of other computer programs and provides scheduling, input-output control, file and data management, memory management, and communication control and related services. It is contemplated by the inventors that the application 76 for implementing exemplary embodiments may be applicable on all commercially available operating systems.

Application 76 may be a source program, executable program (object code), script, or any other entity comprising a set of instructions to be performed. When a source program, then the program is usually translated via a compiler, such as the compiler 74, assembler, interpreter, or the like, which may or may not be included within the memory 72, so as to operate properly in connection with the O/S 75. Furthermore, the application 76 can be written as an object oriented programming language, which has classes of data and methods, or a procedure programming language, which has routines, subroutines, and/or functions, for example but not limited to, C, C++, C #, Pascal, BASIC, API calls, HTML, XHTML, XML, ASP scripts, JavaScript, FORTRAN, COBOL, Perl, Java, ADA, .NET, and the like.

The I/O devices 73 may include input devices such as, for example but not limited to, a mouse, keyboard, scanner, microphone, camera, etc. Furthermore, the I/O devices 73 may also include output devices, for example but not limited to a printer, display, etc. Finally, the I/O devices 73 may further include devices that communicate both inputs and outputs, for instance but not limited to, a modulator/demodulator for accessing remote devices, other files, devices, systems, or a network, a radio frequency (RF) or other transceiver, a telephonic interface, a bridge, a router, etc. The I/O devices 73 also include components for communicating over various networks, such as the Internet or intranet.

If the device 70 is a PC, workstation, intelligent device or the like, the software in the memory 72 may further include a basic input output system (BIOS). The BIOS is a set of essential software routines that initialize and test hardware at startup, start the O/S 75, and support the transfer of data among the hardware devices. The BIOS is stored in some type of read-only-memory, such as ROM, PROM, EPROM, EEPROM or the like, so that the BIOS can be executed when the device 70 is activated.

When the device 70 is in operation, the processing circuitry 71 is configured to execute software/executable instructions stored within the memory 72, to communicate data to and from the memory 72, and to generally control operations of the device 70 pursuant to the software/executable instructions. The application 76 and the O/S 75 are read, in whole or in part, by the processing circuitry 71, perhaps buffered within the processing circuitry 71, and then executed.

When the application 76 is implemented in software it should be noted that the application 76 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 76 can be embodied in any computer-readable medium for use by or in connection with an instruction execution system, apparatus, or device, such as a computer-based system, processing circuitry-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

In the context of the present disclosure, the I/O devices 73 may be configured to receive the input datasets from a medical imaging device 100. In another example, the input datasets are obtained from a memory arrangement or unit (not shown).

The I/O devices 73 may be configured to provide the output dataset(s) to the user interface 111. The user interface 111 may be configured to provide a visual representation of the output dataset(s), e.g. display an image (or images) corresponding to the medical imaging data contained in the output dataset(s).

The skilled person would be readily capable of developing a device having processing circuitry for carrying out any herein described method. Thus, each step of the flow chart may represent a different action performed by the processing circuitry of a device, and may be performed by a respective module of the processing circuitry of the device.

Embodiments may therefore make use of a device. The device can be implemented in numerous ways, with software and/or hardware, to perform the various functions required. A processor is one example of a device which employs one or more microprocessors that may be programmed using software (e.g., microcode) to perform the required functions. A device may however be implemented with or without employing a processor, and also may be implemented as a combination of dedicated hardware to perform some functions and a processor (e.g., one or more programmed microprocessors and associated circuitry) to perform other functions.

Examples of device components that may be employed in various embodiments of the present disclosure include, but are not limited to, conventional microprocessors, application specific integrated circuits (ASICs), and field-programmable gate arrays (FPGAs).

In various implementations, a processor or device may be associated with one or more storage media such as volatile and non-volatile computer memory such as RAM, PROM,

EPROM, and EEPROM. The storage media may be encoded with one or more programs that, when executed on processing circuitry, perform the required functions. Various storage media may be fixed within a processor or device or may be transportable, such that the one or more programs stored thereon can be loaded into a processor or device.

It will be understood that disclosed methods are computer-implemented methods. As such, there is also proposed the concept of a computer program comprising code means for implementing any described method when said program is run on a device containing processing circuitry, such as a computer. Thus, different portions, lines or blocks of code of a computer program according to an embodiment may be executed by a device or computer to perform any herein described method. In some alternative implementations, the functions noted in the block diagram(s) or flow chart(s) may occur out of the order noted in the figures. For example, two blocks shown in succession may, in fact, be executed substantially concurrently, or the blocks may sometimes be executed in the reverse order, depending upon the functionality involved.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to”θ is used in the claims or description, it is noted the term “adapted to”θ is intended to be equivalent to the term “configured to”. Any reference signs in the claims should not be construed as limiting the scope.

1. A computer-implemented method of processing projection domain data generated by a computed tomography (CT) scanner, the computer-implemented method comprising:
obtaining a first input dataset comprising projection domain data generated by the CT scanner at a desired imaging angle, wherein the CT scanner is configured to generate projection domain data at different imaging angles with respect to an examination region in a scanning operation;
obtaining at least one further input dataset, each comprising projection domain data generated by the CT scanner at a respective at least one further imaging angle, wherein a difference between the desired imaging angle and each respective further imaging angle is predetermined;
inputting the first input dataset and the at least one further input dataset to a machine-learning algorithm, wherein the machine-learning algorithm is configured to process the first input dataset and the at least one further input dataset to generate an output dataset, wherein the output dataset is different to the first input dataset and comprises projection domain data at the desired imaging angle with respect to the examination region; and
processing, using the machine-learning algorithm, the first input dataset and the at least one further input dataset to generate the output dataset.

2. The computer-implemented method according to claim 1, further comprising using the machine-learning algorithm to reduce, based on the first input dataset and the at least one further input dataset, noise and/or artefacts in the projection domain data of the first input dataset to thereby generate the output dataset.

3. The computer-implemented method according to claim 1, further comprising using the machine-learning algorithm to perform, based on the first input dataset and the at least one further input dataset, spectral filtering of the projection domain data of the first input dataset to generate the output dataset.

4. The computer-implemented method according to claim 1, wherein the at least one further input dataset comprises a first further input dataset comprising projection domain data generated by the CT scanner at a first imaging angle, the difference between the desired imaging angle and the first imaging angle being equal to π.

5. The computer-implemented method according to claim 1, wherein, for each of the at least one further input dataset, the difference between the desired imaging angle and the respective further imaging angle is a multiple of a first predetermined angle.

6. The computer-implemented method according to claim 5, wherein the first predetermined angle is equal to the smallest change in imaging angle carried out by the CT scanner during a scanning operation.

7. The computer-implemented method according to claim 6, wherein the at least one further input dataset comprises:
a second further input dataset comprising projection domain data generated by the CT scanner at a second imaging angle, wherein the difference between the desired imaging angle and the second imaging angle being the first predetermined angle; and
a third further input dataset comprising projection domain data generated by the CT scanner at a third imaging angle, wherein the difference between the third imaging angle and the desired imaging angle is the first predetermined angle.

8. The computer-implemented method according to claim 7, wherein the at least one further input dataset comprises:
a fourth further input dataset comprising projection domain data generated by the CT scanner at a fourth imaging angle, wherein the difference between the desired imaging angle and the fourth imaging angle being a second predetermined angle, wherein the second predetermined angle is greater than the first predetermined angle; and
a fifth further input dataset comprising projection domain data generated by the CT scanner at a fifth imaging angle, wherein the difference between the fifth imaging angle and the desired imaging angle is the second predetermined angle.

9. The computer-implemented method according to claim 1, wherein the at least one further input dataset comprises no more than ten further input datasets.

10. The computer-implemented method according to claim 1, wherein:
the CT scanner is configured to generate projection domain data for each of a plurality of different parts of a projection volume with respect to the subject, wherein the projection volume is a volume of the examination region, and
each of the at least one further input dataset is configured to comprise projection domain data having a part of the projection volume that at least partly overlaps the part of the projection volume of the projection domain data of the first input dataset.

11. The computer-implemented method according to claim 10, further comprising, for each of the at least one further input dataset prior to inputting the first input dataset and the at least one further input dataset into the machine-learning algorithm:
processing the further input dataset to remove any portions of the projection domain data of the further input dataset that correspond to parts of the projection volume of the projection domain data of the further input dataset that do not overlap the projection volume of the first input dataset.

12. The computer-implemented method according to claim 1, wherein the CT scanner comprises:
a rotating gantry that rotates about a center of rotation;
a radiation source rotatably supported on the rotating gantry and configured to rotate with the rotating gantry and emit radiation that traverses the examination region; and
a detector array rotatably supported on the rotating gantry and configured to rotate with the rotating gantry and generate projection domain data responsive to radiation emitted by the radiation source through the examination region,
wherein the imaging angle is an angle that the radiation source makes with respect to a horizontal plane.

13. A non-transitory computer-readable medium for storing executable instructions, when executed by processing circuitry, cause the processing circuitry to perform the method according to claim 1.

14. (canceled)

15. A device configured to process projection domain data generated by a computed tomography (CT) scanner, the device comprising:
processing circuitry; and
a memory containing instructions that, when executed by the processing circuitry, configure the processing circuitry to:
obtain a first input dataset comprising projection domain data generated by the CT scanner at a desired imaging angle, wherein the CT scanner is configured to generate projection domain data at different imaging angles with respect to an examination region in a scanning operation;
obtain at least one further input dataset, each further input dataset comprising projection domain data generated by the CT scanner at a respective at least one further imaging angle, wherein the difference between the desired imaging angle and each respective further imaging angle is predetermined;
input the first input dataset and the at least one further input dataset to a machine-learning algorithm, wherein the machine-learning algorithm is configured to process the first input dataset and the at least one further input dataset to generate an output dataset, wherein the output dataset is different to the first input dataset and comprises projection domain data at the desired imaging angle with respect to the examination region; and
process, using the machine-learning algorithm, the first input dataset and the at least one further input dataset to generate the output dataset.
